(19) United States
(12) Patent Application Publication
(10) Pub. No.: US 2016/0232034 A1
(43) Pub. Date: Aug. 11, 2016

(54) Processing an Action Based on an Attribute

(71) Applicant: LONGSAND LIMITED, Cambridge, Cambridgeshire (GB)

(72) Inventors: Sean Blanchflower, Cambridge, Cambridgeshire (GB); Fernando Lucini, Cambridge, Cambridgeshire (GB)

(21) Appl. No.: 15/022,452

(22) PCT Filed: Sep. 30, 2013
(86) PCT No.: PCT/EP2013/070383

§ 371 Date: Mar. 16, 2016

(51) Int. Cl. G06F 9/50

(52) U.S. Cl. CPC G06F 9/505; G06F 9/5038

(57) ABSTRACT

In one implementation, an action may be processed based on an attribute. An attribute of an action may be determined. A complexity value of the action may be evaluated based on the attribute and independent of a system state. The action may be positioned in a workflow based on a time unit length for execution of the action.

### BACKGROUND

A service may be implemented using a distributed computing system. For example, a service may be made available to clients over a cloud-based architecture. A service request may be commonly sent to a processor resource for execution based on the state of the computing system. For example, a load balancer may perform a computation to determine which processor resource has a relatively low resource utilization and should receive the service request.

Pattern analysis services may require relatively large input parameters with the service request. For example, thousands of documents may be analyzed to discover a name or a concept within the documents. Uploading times for such data to be analyzed by the service can create a significant time delay and, consequently, longer execution times for workflows of a set of actions.

### BRIEF DESCRIPTION OF THE DRAWINGS

FIGS. 1, 2, 3, and 4 are flow diagrams depicting example methods for processing an action.

FIGS. 5 and 6 are block diagrams depicting example systems for processing an action.

FIG. 7 depicts example environments in which various examples for processing an action may be implemented.

### DETAILED DESCRIPTION

In the following description and figures, some example implementations of systems and/or methods for processing an action are described. Some examples are described specifically for use in a cloud-based computing environment and for data analysis. However it should be noted that examples of processing an action described herein may be utilized in a variety of appropriate systems and applications. In particular, a system for processing an action may process an action in a system utilizing a workflow to process an action. Therefore, cloud computing environments and data analysis services are merely potential uses of the systems and methods for processing an action. Thus any reference to elements and/or methods specific to cloud computing or data analysis is included to provide context for specific examples described herein unless otherwise indicated.

Cloud computing is a common form of distributed computing that utilizes a shared pool of computing resources. For example, the shared pool of resources may be distributed across machines within a cloud system. The computing environment, including the shared pool of resources, may be referred to as a “cloud.” As used herein, a cloud may be any combination of physical and virtual resources pooled for computing and/or storage purposes. For example, a cloud may include any appropriate number of individual resources, servers, and server groups, including virtual instances of resources, servers, and/or server groups executing on a virtual machine. As used herein, a cloud network may include any appropriate number of clouds and/or other network of resources accessible by a network device.

The pool of computing resources may provide a service. As used herein, a service may be any appropriate supplying of communication, transmissions, information, computations, software, storage, or any other product or activity that may be capable of running on the cloud. One example of a service may be a pattern analysis service to determine a pattern of a set of input data. A cloud-based service is said to execute or reside “on the cloud.”

A service may allow for actions to be requested. For example, an action request of a database service may include an insert action to insert an entry to the database, a delete action to delete an entry from the database, a modify action to modify an entry in the database, and query action to search the entries of the database. A service may allow for actions to be received in any appropriate order and at any appropriate rate. For example, the service may execute action on a first-in first-out basis. A request may be received out of order or in a relatively inefficient order. For example, a request to search a database for the term “race car” may be received prior to adding a set of driver magazines to the database. Some action request may take longer than others and may be capable of operating in parallel with other actions.

Various examples described below relate to processing an action based on an attribute of the action. By developing a workflow based on an attribute of the function, the action may be executed in an efficient and intelligent way in sequence with other action requests.

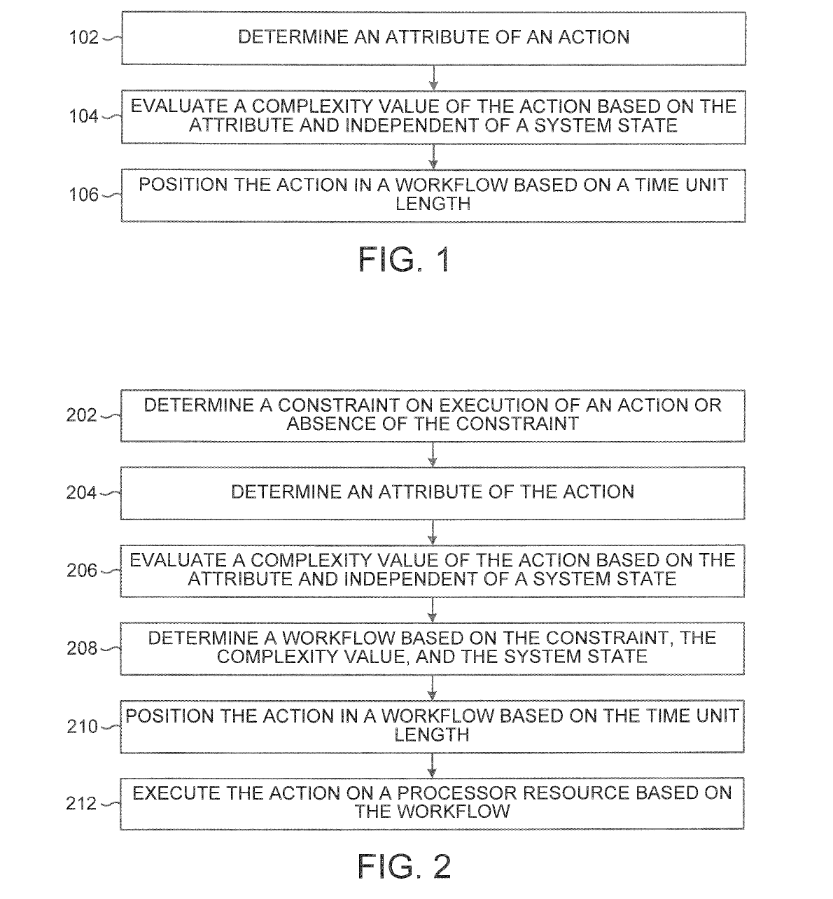

FIGS. 1, 2, 3, and 4 are flow diagrams depicting example methods for processing an action. Referring to FIG. 1, example methods for processing an action may generally comprise determining an attribute of an action, evaluating a complexity value of the action based on the attribute, and positioning the action in a workflow based on a time unit length. The terms “including” and “having,” and variations thereof, as used herein, have the same meaning as the term “comprising.”

At block 102, an attribute of an action may be determined. An action may be any task, function, or other appropriate request made to a system providing a service. For example, a list action may provide a list of all the data currently in a database. An attribute may be any appropriate characteristic, input value, output value, purpose, or other appropriate data associated with the action. For example, an attribute may include a set of input data, an action result, a database used, an action type or category, an action group, a user requesting the action, an action history, a number of actions, a time of request, an order of operations, an input data size, a result size, and/or a characteristic associated with one of the above. An attribute may be indirectly related to the action and may be independent of a system state, such as independent of resource utilization of the system to execute the action.

An action request, or a request to execute the action of the service, may contain the attribute. For example, the attribute may be based on the input parameters of the action request. The attribute may be determined by examining the action request. For example, the attribute may be determined by at least one of parsing the action request and interpreting the action request. Parsing the action request may include dividing the characters of the request. For example, the input parameter of “Doc1” and the action type of “Search” may be parsed from a search action request for the term “email” that may take the form of “Search(Doc1, email).” Interpreting the action request may include analysis and/or prediction of the action request. For example, a search action request may have a relatively higher degree of operations than an action request to list the title or other property of the document to search. The attribute may be determined by examination logic based on at least one of a predetermined programming, the action request, and a processing system. For example, the system may understand which action requests may be received and what attribute may be associated with each action.

At block 104, a complexity value of the action may be evaluated based on the attribute and independent of a system state. A complexity value may be a number, a character, a category, a label, or any other appropriate data to represent a degree of complexity of the action. The degree of complexity may be associated with the attribute of the action. For example, the complexity value may include at least one of a computation value related to an order of operations (or a degree of operations) executed by the action, a data size value related to a size of the input data or other data used by the action, and a result size value related to a size of a result returned by the action. The complexity value may be evaluated by comparing, categorizing, mapping, testing, or otherwise analyzing the action request based on an attribute of the action.

A complexity value may be evaluated by assessing the attribute of the action. For example, the order of operations may be tested or the data size may be within a range to determine whether the input data is large, medium, or small. An assessment may come in the form of categorizing, estimating, analyzing, predicting, testing, or otherwise judging the type, character, and/or value of the attribute. The complexity value may be evaluated from evaluation logic based on at least one of a predetermined programming, the action request, and a processing system. For example, the system may understand which attributes may exist, the degree of complexity related to each attribute, and how the attribute may affect the complexity of each action to determine the complexity value.

The complexity value may describe the degree of complexity of the action independent of a system state, or state of the system processing (or executing) an action. For example, an order of operations may be an attribute that describes the complexity of the action, and the complexity of execution of the action may be described by the order of operations without considering the state of the system. Using an attribute to determine a complexity value without considering a system state may allow a workflow to be efficient without regard to the system that may perform the action. For example, in a cloud-based computing system, a workflow may be sent to the cloud for execution in an optimized way, where the cloud may handle appropriate load balancing. The workflow may then be further modified to account for the system state as discussed in more detail in the description associated with FIGS. 2-6.

At block 106, the action may be positioned in a workflow based on a time unit length for execution of the action. The time unit length may represent an execution time for the action as discussed below and in more detail in the description associated with FIGS. 2-6. A workflow may be any appropriate form of a categorization or structure to determine how a system may execute a set of actions. For example, a workflow may include a pattern for execution of a set of actions. A pattern may be an arrangement and sequence of the set of actions. For example, the pattern may be a linear sequential pattern or include a branching arrangement to execute a set of actions concurrently. The pattern may include a position in an order of execution. A pattern may include a plurality of positions for a plurality of actions. Positions may be arranged based on constraints, such as dependencies, and flexibility, such as independencies for concurrent processes. A workflow may be organized to execute the action in an efficient matter. For example, the workflow may describe a two-branch pattern for executing action requests for data insertions on a first branch while action requests for database queries execute on a second branch.

The pattern for execution may be based on the complexity value. For example, the arrangement of positions of the pattern may describe execution of dependent actions after independent actions and actions of low complexity may be executed on a first branch of the pattern while actions of high complexity may be executed on a second branch. A pattern may include any predetermined solutions for executing a set of actions and arrangements created at runtime, or otherwise modified dynamically at runtime.

As mentioned, the time unit length may represent an execution time of the action. For example, the time unit length may be a number of time units to represent the time that may be used to perform the action. A time unit may be any appropriate value, label, or other data designated by the software, the user, the query, or the system to represent a period of time. For example, a time unit may represent a tenth of a second or a period of time of an average processor cycle. The time unit length may be any value, or other data, based on a time unit. The time unit may be independent of actual execution time and/or a system state to allow the time unit lengths to be comparable across actions. For example, the time unit length of a first action may be comparable to the time unit length of a second action. The time unit length of an action may be based on the complexity value. For example, the complexity value may be used to look up an approximate time unit length in a time unit length table. The time unit length may be a value independent of the system state. For example, an insert action request may be three time units, a query action request without wildcards may be five time units, and a query action request with wildcards may be ten times each wildcard in the query. Alternatively, the time unit length may consider the system state. For example, the time unit length may be doubled for execution on a processor resource that has a 50% utilization state. The time unit length may be derived from the complexity value. For example, a time unit length of a first action may be determined based on whether the first action has a higher complexity value or a lower complexity value compared to a second action.

The action may be positioned in the pattern based on the time unit length. For example, a first branch of the pattern may execute actions having a time unit length of one through five while a second branch may execute actions having a time unit length greater than five. Positioning the action based on the time unit length of the action may increase the efficiency of the workflow. As discussed in more detail in the description associated with FIGS. 2-6, the workflow and/or the position of the action in the workflow may be based on the complexity value, the constraints on execution, and the system state.

FIG. 2 includes similar blocks as FIG. 1 and provides additional blocks and additional details. In particular, FIG. 2 depicts additional blocks and details generally regarding determining a constraint on execution of the system; determining a workflow based on the constraint on execution, a complexity value, and a system state; and executing the action based on the workflow. Accordingly, the description associated with FIG. 2 may provide additional details regarding blocks 202, 208, and 212. The blocks 204, 206, and 210 of FIG. 2 are similar to blocks 102, 104, and 106 of FIG. 1, respectively, and, for brevity, the associated descriptions are not repeated.

At block 202, a constraint on execution of an action or an absence of a constraint may be determined. A constraint may be any appropriate restriction on the execution of an action to affect the workflow. For example, when analyzing unstructured data, an action to search for results discussing vehicles may be dependent on an action to discover the language of the unstructured data to know what terms to use in the search.

At block 208, a workflow may be determined based on a constraint, a complexity value, and a system state. As mentioned above, the complexity value may be used to develop a workflow to execute an action in an efficient manner, such as through concurrent execution. Unlike a workflow based on complexity, a constraint may determine a fixed position of an action in the workflow and/or in relation to a second action in the workflow. A system state may also affect whether one workflow is more efficient than another. For example, if a processor resource has a relatively high resource utilization, then a workflow may adapt to reroute a request to another processor resource by adding to the branch of the workflow being sent to that processor resource. The combination of a constraint, a complexity value, and a system state may provide comprehensive view of processing an action in a workflow.

A workflow may designate the order of actions to increase efficiency. An action may be grouped into workflow group containing a plurality of actions associated with an attribute. For example, an action may have the same input parameters or same search scope as a plurality of actions and the input parameters or search scope may be utilized over each action in the workflow group rather than repeatedly passing around the input parameter or data within the search scope. A cloud computing environment may allow for the input parameter of an action to be distributed across actions being executed and the workflow may efficient by utilizing this capability.

At block 212, the action may execute on a processor resource based on the workflow. For example, the workflow may determine which processor resource may execute the workflow. The processor resource may be selected from a plurality of processor resources of a distributed system. As mentioned previously, a cloud computing environment may handle which particular processor resource may execute an action. The example methods described herein could execute within the cloud computing environment or in conjunction with the cloud computing environment to assist in determining which particular processor resource may execute an action within a workflow.

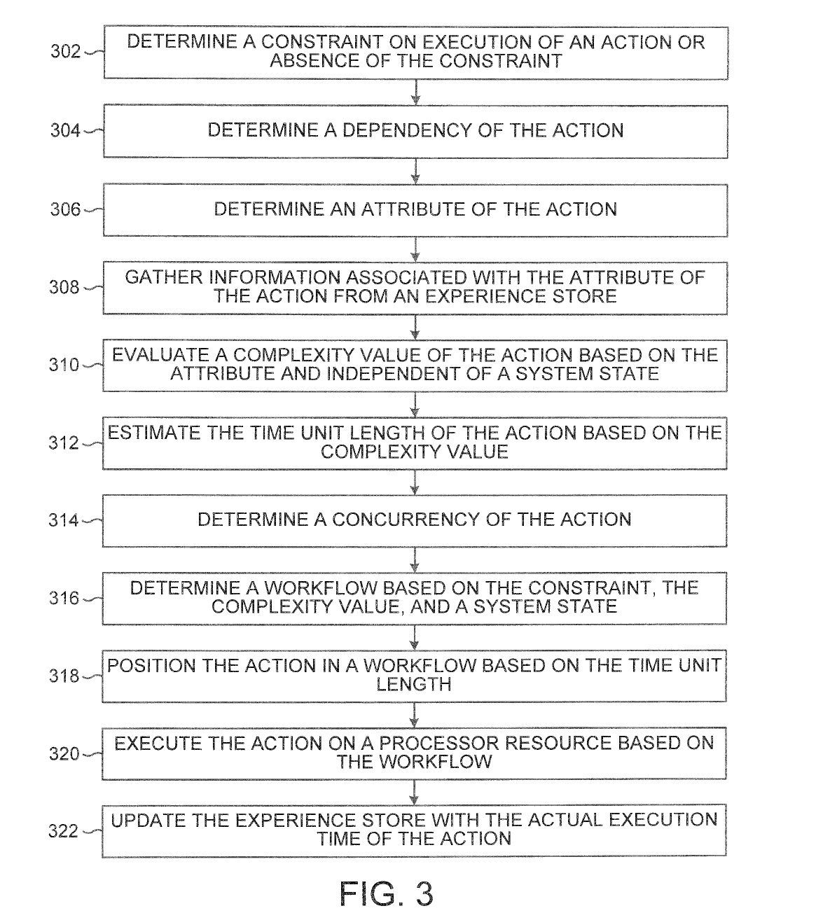

FIG. 3 includes similar blocks as FIG. 2 and provides additional blocks and additional details. In particular, FIG. 3 depicts additional blocks and details generally regarding determining a dependency and a concurrency; gathering information associated with an attribute; estimating a time unit length; and updating the information associated with the attribute. Accordingly, the description associated with FIG. 3 may provide additional details regarding blocks 304, 308, 312, 314, and 322. The blocks 306, 310, 318, 302, 316, and 320 of FIG. 3 are similar to the blocks 102, 104, and 106 of FIG. 1 and the blocks 202, 208, and 212 of FIG. 2, respectively, and, for brevity, the associated descriptions are not repeated.

At block 304, a dependency of the action may be determined. A dependency may be a constraint that may limit the possible workflows available to perform a set of actions based on a relationship between the set of actions. For example, a first action may be determined to depend on execution of a second action of a plurality of actions designated for a workflow. A dependency may be direct or implied. For example, a first action may include a direct dependency if it utilizes the result of a second action in executing the first action and a first action may include an implied dependency if the results of the first action would be improved by executing the second action before the first action, such as executing an insert action request before a query action request, even though the first action does not rely on the results of the second action. Determining an implied dependency may be useful in determining a position of the action in a workflow. For example, the action may be positioned in the workflow to execute after the first action of the plurality of actions. By placing an independent action in a position in the workflow so that any appropriate dependent actions on that independent action are executed after the independent action, efficiency of the workflow and accuracy of the results may be improved.

At block 308, information associated with the attribute of the action may be gathered from an experience store. The experience store may contain a set of historical data related to an attribute. For example, the set of historical data may be related to prior execution history associated with the attribute. The experience store may include data associated with previous actions, such as attributes of previously executed actions and actual execution times of previous actions. For example, the experience store may contain at least one of a set of heuristic data related to discovery of the complexity value of the action, a set of benchmark data related to a point of reference for the complexity value of the action, a set of test data related to the previous action, and other statistical data. The experience store may contain a set of prediction data. For example, the experience store may contain a table of an estimation of a time unit length of an attribute or a set of data to use in computing a projection of complexity value when a wildcard is used in an action request.

The information from the experience store may be used to determine the complexity value. For example, the action request with the same input parameters may have been executed previously and the complexity value may be estimated to be the same as the previous time it was executed. For another example, the action request be similar to a previously executed action by may include a wildcard and the experience store may contain a base complexity value and a multiplier based on the wildcard to project the complexity value of the action request.

At block 312, a time unit length of the action may be estimated based on the complexity value. For example, a table may be used to convert the complexity value to a time unit length. As mentioned above, the time unit length may be based on time units that are independent of the system state and actual execution. An action may include multiple attributes and the complexity values of each attribute may be used to determine the time unit length. For example, the largest complexity value of the attributes of the action may be used to determine a time unit length or the complexity values may be added together before determining a time unit length. A complexity value may be used in conjunction with the system state to determine a time unit length that may represent an estimated execution time.

A time unit length may be estimated on a type of action that has little or no historical data associated with it. For example, the system may adapt to a search request, not previously executed, by using the complexity value of an attribute of the search request based on similar previous search requests. For another example, a set of seed data may establish a prediction starting point, or base point, based on the set of historical data of the experience store if the action has not been executed before or otherwise has no relatable historical data to use from the experience store. Estimation may be made based on incomplete assessment, hypothesis testing, or an average complexity and/or time unit length and the estimation may be updated as the action request is executed. A learning system may be used to determine the time unit length may be estimated for an attribute that has not been previously executed before and based on tests or other execution history, the learning system may develop a complexity value and/or a time unit length associated with the attribute. The learning system may be based on Bayesian methods of machine-based learning.

At block 314, a concurrency of the action may be determined. A first action may be determined to be concurrently executable with a second action of the plurality of actions. To improve efficiency, a workflow may be selected to allow processing an action in parallel, at least in part, with other actions. For example, an action request to list all the documents of a database may be executed in parallel with an action request to query the database for a term. The constraint determination may assist in determining which actions may be available for concurrent execution (or processing). The complexity value and/or the time unit length may be used to determine the position in the workflow that utilizes concurrent processing. For example, a first action may be positioned in a workflow to execute concurrently with a second action of the plurality of actions based on the time unit length.

At block 322, the experience store may be updated with the actual execution time of the action. An actual execution time of an action may be the time from when the processor resource began execution of the action to the time execution was completed. The actual execution time may be convertible to a time unit length that is representative of time units independent of the system state. The actual execution time and/or the time unit length may be used to update other data in the experience store. For example, an average execution time of search action requests may be kept to determine the time length unit based on the complexity value and the average execution time may be updated with the actual execution time. Updating the experience store may facilitate an accurate estimation of a complexity value and/or a time unit length. The experience store may integrate into a learning system.

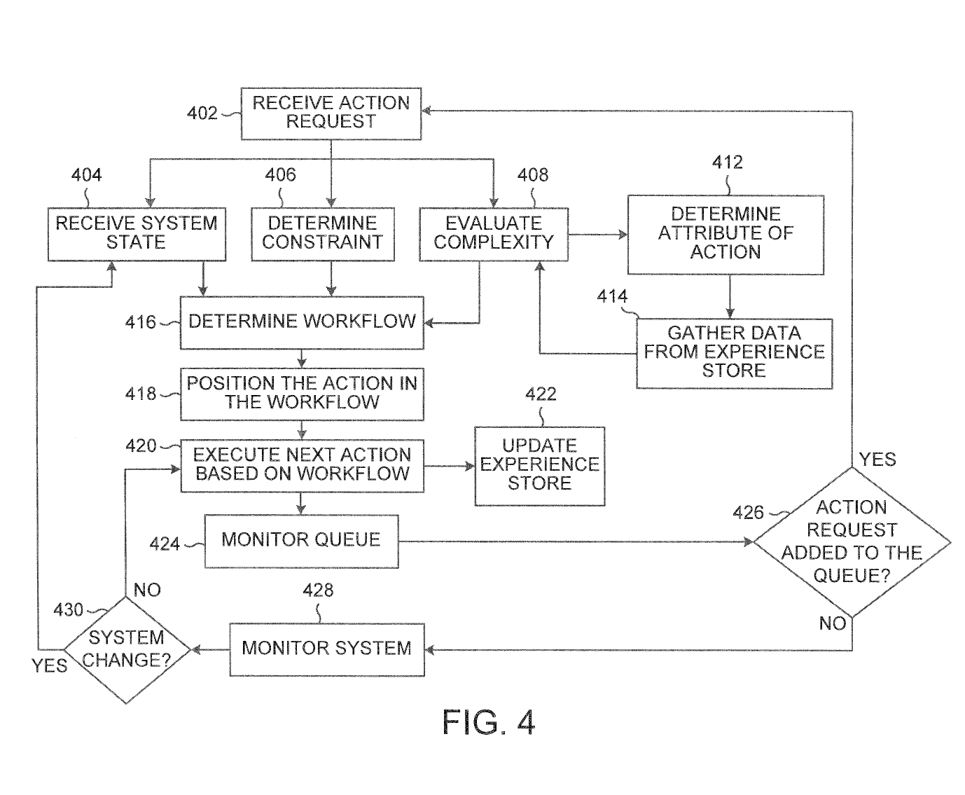

FIG. 4 includes similar blocks as FIGS. 1, 2, and 3, and may provide additional blocks and additional details. In particular, FIG. 4 depicts example orders of execution and example relationships among blocks depicted in FIGS. 1, 2, and 3. For brevity, the descriptions associated with FIGS. 1, 2, and 3 are not repeated in their entirety.

At block 402, an action request may be received. The action request may be added to a queue of action requests. The queue may hold an initial position of the action request and may allow for the action request to be reordered once a workflow is determined as discussed with blocks 416 and 418. The action request may flag processing for determining a workflow, such as obtaining a system state, determining if a constraint on execution exists, and evaluating the degree of complexity of the action request. Reception of an action request may initiate a method for determining a workflow. As discussed in the description associated with blocks 424 and 428, a workflow determination may initialized at runtime based on at least one of receiving a second action request and receiving a system event associated with the system state.

At block 404, a system state may be received. The system state may be used at block 416 to determine whether the workflow should compensate for the system state or otherwise be modified based on the state of the system.

At block 406, a constraint on execution may be determined. The queue of action requests may be analyzed to determine if a constraint exists with the plurality of actions in the queue. For example, an insert action request may need to be executed prior to a search action request. The system may also have a constraint on execution of the action.

At block 408, a complexity value may be evaluated. A complexity value may be determined based on an attribute of the action and data related to the attribute during previous action executions. The complexity value may be used to determine a time unit length.

At block 412, an attribute of the action may be determined. The action request may be analyzed, such as by parsing or interpreting, to discover an attribute of the action. The discovery of an attribute may be based on system-defined logic, query-defined logic, preprogrammed logic, and/or machine-learning logic.

At block 414, data may be gathered from an experience store. The experience store may contain information, such as historical data, to be used in evaluating the complexity value of the action. The time unit length may be estimated based on data stored in the experience store. For example, the time unit length may be based on at least one of a set of historical data related to prior execution history associated with the attribute, a set of prediction data related to an estimation of the time unit length based the attribute, and a set of seed data to establish a prediction starting point based on the set of historical data related to the attribute.

At block 416, a workflow may be determined. The workflow may be determined based on a complexity value. The workflow may also be determined based on the system state and a constraint on execution, if one exists. The workflow may include a pattern for execution of a plurality of actions associated with the workflow. The plurality of actions may be reordered from the order received in the queue to increase efficiency and/or accuracy of results of the execution of the workflow. A concurrency of the plurality of actions may be determined to allow for some of the plurality of actions to execute in parallel. The workflow may be based on a dependency of the action (discovered at block 406) and a concurrency of the action. The workflow may be established by creating the workflow based on the constraints and the concurrency determination or by selecting a workflow from a set of workflows. A workflow may be created by selecting a workflow and modifying it for the possible dependencies and concurrencies associated with the plurality of actions.

The time unit length of each of the plurality of actions may be used to determine the workflow and/or the position of the workflow. The time unit length may be used in computations to determine the workflow. For example, a numerical optimization technique, such as optimization techniques using matrices, may be used to minimize the execution time of the workflow of the plurality of actions based on the time unit length.

At block 418, the action may be positioned in the workflow. The pattern of the workflow may include multiple positions. Based on the time unit length (calculated based on the complexity value), the position of the action in the workflow may be determined.

At block 420, a next action may be executed based on the workflow. The next action may be executed serially, in parallel, or in partial concurrence. The action received at block 402 may be the next action or the action may wait until the position associated with the action is designated next for execution.

At block 422, the experience store may be updated. The experience store may be updated with any appropriate information learned or as a result of executing the action. For example, an actual execution time may be added to the experience store to update the time unit length table.

At block 424, the queue may be monitored. The queue may receive a second action request. An event may be sent or a flag set to notify the system that a second action request has been sent to the queue. The workflow may be selected, created, adapted, replaced, or otherwise determined to obtain a position of the second action in the workflow.

At block 426, a decision may be made as to whether a second action request has been added to the queue. If a second action has been added to the queue, then the workflow may be modified, or otherwise determined, in accordance with the second action by continuing the example method to block 402. If a second action has not been added to the queue, then the workflow may continue to execute if the system state is similar as determined by a system monitor at block 428.

At block 428, a decision may be made as to whether there has been a change in the system since the last workflow determination. If there has been a change, then the system state may be received at block 404 and used to determine a workflow at block 416 to compensate for the change in system state. If there has not been a change in the system state, then the workflow may continue to execute at block 420.

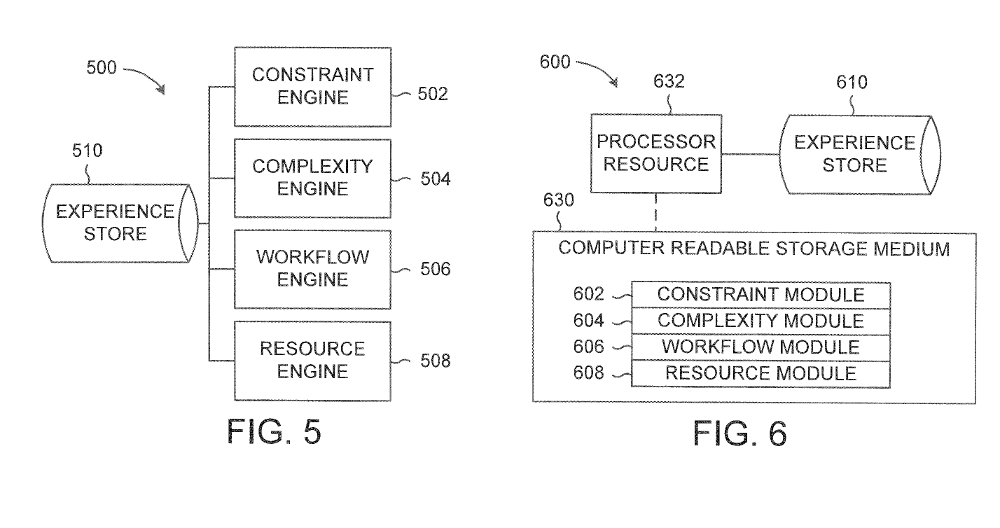

FIGS. 5 and 6 are block diagrams depicting example systems for processing an action. Referring to FIG. 5, an example system 500 for processing an action may generally include a constraint engine 502, a complexity engine 504, and a workflow engine 506. The example system 500 may also include a resource engine 508 and an experience store 510.

The constraint engine 502 may represent hardware, software, or a combination thereof, such as firmware, configured to determine a constraint on execution of the action. The constraint engine 502 may be configured to evaluate, interpret, or otherwise analyze an action request to determine whether a constraint on execution of the action may exist or not. For example, the constraint engine 504 may receive a detect language action request, determine the detect language action has no constraints, and report the absence of a constraint to the workflow engine 506 and/or complexity engine 504. A constraint may restrict the pattern of the workflow based on the action request and/or the processing system. A constraint was discussed in more detail in the description associated with FIGS. 2 and 4.

The complexity engine 504 may represent hardware, software, or a combination thereof configured to evaluate a complexity value of the action based on an attribute of the action and independent of a system state. The complexity engine 504 may evaluate the complexity value of the action by determining an attribute of the action, gathering a set of complexity information associated with the attribute, and evaluating the complexity information to determine the complexity value.

The complexity value may be convertible or otherwise transformable, possibly based on other factors, to a time unit length independent of a system state. The complexity value and/or the time unit length may be based on an evaluation independent of a system state and comparable across systems and states of processor resources. The complexity value and/or time unit length may be used to produce a workflow that may execute efficiently without regard to the system state. The system state may be of use to improve efficiency of the workflow on a particular machine or system as discussed in more detail in the description associated with the workflow engine 506 and the resource engine 508.

The complexity engine 504 may be configured to derive an attribute from an action. For example, the complexity engine 504 may parse an action request to discover an input parameter and use the input parameter as an attribute. The complexity engine 504 may derive the attribute from an action request based on at least one of a set of program-defined logic, a set of query-defined logic, a set of system-defined logic, and a set of machine-learning logic. A set of program-defined logic may be a set of conditional instructions constructed within the software executing the service to make logic determinations. A set of query-define logic may be a set of conditional instructions that are received with the action request. A set of system-defined logic may be a set of conditional instructions constructed within the system, such as a cloud environment. A set of machine-learning logic may be a set of logic used by a machine-learning program or system to develop intelligence in discovering an attributes, a complexity value, and/or a time unit length. Logic may be executable instructions, electronic circuitry, or a combination thereof.

The complexity engine 504 may be configured to gather a set of complexity information related to the action from the experience store 510 based on the attribute. The complexity engine 504 may retrieve data from the experience store 510 to determine an attribute of an action. For example, the experience store 510 may include a table that maps types of searches to complexity values, such as a query for tagging names of people in unstructured data may be associated with a table entry having a lower complexity value than the complexity value associated with determining the language of the unstructured data.

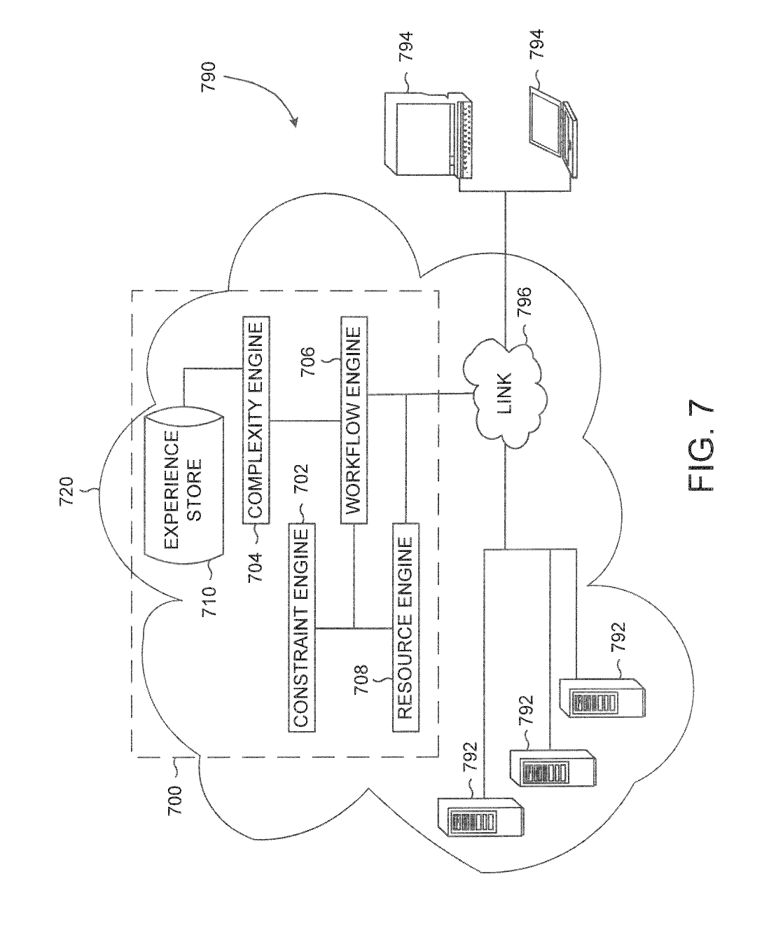

As discussed in more detail in the description associated with FIGS. 6 and 7, the experience store 510 may be a medium configured to store data. The experience store 510 may contain a set of historical data and/or a set of prediction data. For example, the experience store 510 may contain at least one of a set of heuristic data related to discovery of the complexity value of the action, a set of benchmark data related to a point of reference for the complexity value of the action, and a set of test data associated with a related action, such as a previously executed action that may have a similar attribute as the action.

The historical, statistical, and/or predictive data of the experience store 510 may be used to determine a complexity value of an action. The data within the experience store 510 may be used to determine a complexity value of an action that has not been executed on the system previously. The system may utilize similar attributes, such as action request types, structures, or input data, to determine a complexity value of an action not previously executed based on the complexity value associated with actions and attributes similar or otherwise associated with the action not previously executed. An estimation of the complexity value may be made and updated once the action is executed to improve estimation for the next action received by the system. The system may include a table and/or logic to determine if a first attribute is similar to a second attribute or how a complexity value may be related between a first attribute to a second attribute. For example, the first attribute may be an attribute of previously executed action and may have a magnitude larger of operations compared to a second attribute of action not previously executed by the system and the complexity value may be adjusted accordingly by the complexity engine 504.

The complexity engine 504 may be configured to predict the time unit length for execution of the action based on the complexity value derived from the set of complexity information. The set of complexity information of the experience store 510 may include statistics, heuristics, benchmarks, tests, and other data to assist prediction. Predicting a time unit length may include extrapolation, interpolation, or otherwise estimating a time unit length.

A time unit length may be predicted independent of a system state. For example, the time unit length may be predicted based on previously known time unit lengths of an action having a similar set of attributes as the action for which the time unit length is being predicted. Alternatively, a time unit length may be predicted using the system state as discussed in more detail in the description associated with the workflow engine 506 and the resource engine 508.

The workflow engine 506 may represent hardware, software, or a combination thereof configured to position an action in a workflow based on a time unit length for execution of the action. The time unit length may be associated with the complexity value and the workflow may be based on the complexity value of the action and the constraint on execution. The workflow may include a pattern based on the constraint on execution and the complexity value of the action and the action may be positioned in the workflow based on the time unit length. For example, if the time unit length of the action is relatively short, the action may be executed in the first position of the workflow. If the time unit length of the action is relatively long, the action may be executed in a second or last position of the workflow. Placing an action further in sequence may allow for a second set of action requests to be received and possibly creating a better workflow in considering the second set of action requests. This may be discussed in more detail below.

The workflow may be selected and/or created based on the complexity value of the action and the constraint on execution. In addition, system state may be considered in developing a workflow. For example, a workflow may be developed considering the dependencies and concurrencies of a plurality of actions and the workflow may be modified or adapted to execute on a system based on the system state. The workflow engine 506 may position the action in the workflow once a workflow has been chosen.

The workflow engine 506 may be configured to apply a priority to the action to determine the position of the action in the workflow. The priority of the action may be determined based on at least one of the action request and the historical data of the experience store 510. A priority may be based on an attribute of the action and an experience store 510 may contain a table to associate an attribute with a priority. The priority of the action may also be used in selecting, developing, or otherwise choosing a workflow.

The workflow engine 506 may be configured to apply a workflow rule to the attribute of the action during runtime. The workflow rule may be used to choose a workflow. For example, the workflow logic may use the constraint on execution and the complexity value of the attribute to design a workflow or a select a workflow from a plurality of workflows. More specifically, the workflow rule may provide a set of workflows compatible with the constraint on execution and the complexity value of the action. The workflow rule may be based on at least one of a set of program-defined logic, a set of query-defined logic, a set of system-defined logic, and a set of machine-learning logic.

The workflow engine 506 may be configured to modify the workflow or choose a second workflow dynamically or otherwise during runtime. For example, a first set of actions may be executing based on a determined workflow when a second set of actions may be received and the workflow engine may determine the first set of actions and the second set of actions may be executed concurrently. In that example, a second workflow may be developed to execute the first set of actions and the second set of actions in parallel and the workflow engine 506 may be configured to position the action in a second workflow. The second workflow may differ from the first workflow based on the workflow rule applied to the attribute. For example, a second set of actions may include an attribute that was not considered during the selection of the first workflow, and the second workflow may be developed base on the attribute that was not considered during the selection of the first workflow.

The workflow engine 506 may be configured to compare a set of base information to a set of complexity information to interpret a complexity value difference between the action and a previous action having the attribute. The set of base information may be related to a complexity value of the previous action and retrievable from the experience store 510. The complexity value difference may be used to predict or otherwise determine the time unit length of the action.

The resource engine 508 may represent hardware, software, or a combination thereof configured to monitor the system state of a cloud network. The resource engine 508 may provide the system state to the workflow engine 508. The system state may be used to determine the workflow, a position in the workflow, a time unit length, and/or an execution time prediction. The resource engine 508 may use a system state analysis method to assist the workflow engine 508 to determine an efficient workflow. For example, the resource engine 508 may utilize a load balancing method to determine possible workflows capable by the system.

The workflow engine 508 may position the action in a workflow based on the system state, the complexity value of the action, and the constraint on execution. Positioning the action in a workflow based on the system state, the complexity value of the action, and the constraint on execution may provide a comprehensive view of limitations and capabilities of a workflow to select a workflow that may be efficient or optimal based on the system state, complexity value, and the constraint on execution. For example, if an action having a relatively long time unit length is positioned to execute on a resource that has high resource utilization, the action may be repositioned onto another branch of the workflow and/or on a processor resource that may have lower resource utilization. The system state may be used to determine both the position of an action and the workflow. For example, if the system state shows an increase in resource utilization of the processor resources currently execution the workflow, a branch may be added to the pattern of the workflow to allow more actions to be executed concurrently and/or on a processor resource that may have a lower resource utilization.

The system state provided by the resource engine 508 may be used to predict an actual execution time using the system state and the time unit length. For example, a processor resource that has a relatively low resource utilization may execute the action over a time period closer to the time unit length than a processor resource that has a relatively high resource utilization.

FIG. 6 depicts that the example system 600 for processing an action may be implemented on a memory resource 630 operatively coupled to a processor resource 632. The processor resource 632 may be operatively coupled to the experience store 610. The experience store 610 may be the same as the experience store 510 of FIG. 5 described above.

Referring to FIG. 6, the memory resource 630 may contain a set of instructions that may be executable by the processor resource 632. The set of instructions may implement the system 600 when executed by the processor resource 632. The set of instructions stored on the memory resource 630 may be represented as a constraint module 602, a complexity module 604, a workflow module 606, and a resource module 608. The processor resource 632 may carry out the set of instructions to execute the constraint module 602, the complexity module 604, the workflow module 606, the resource module 608, and/or any appropriate operations between or otherwise associated with the modules of the system 600. For example, the processor resource 632 may carry out a set of instructions to determine a constraint on execution of the action, evaluate a complexity value of the action based on an attribute of the action, and position the action in a workflow based on a time unit length for execution of the action. The constraint module 602 may represent program instructions that when executed function as the constraint engine 502 of FIG. 5. The complexity module 604 may represent program instructions that when executed function as the complexity engine 504 of FIG. 5. The workflow module 606 may represent program instructions that when executed function as the workflow engine 506 of FIG. 5. The resource module 608 may represent program instructions that when executed as the resource engine 508 of FIG. 5.

The processor resource 632 may be one or multiple CPUs capable of retrieving instructions from the memory resource 630 and executing those instructions. The processor resource 632 may process the instructions serially, concurrently, or in partial concurrence, unless described otherwise herein.

The memory resource 630 and the experience store 610 may represent a medium to store data utilized by the system 600. The medium may be any non-transitory medium or combination of non-transitory mediums able to electronically store data and/or capable of storing the modules of the system 600 and/or data used by the system 600. A storage medium, such as memory resource 630, may be distinct from a transmission medium, such as a signal. The medium may be machine-readable, such as computer-readable. The data of the experience store 610 may include representations of attributes, complexity values, time unit lengths, actual execution times, and/or other data or information mentioned herein.

In the discussion herein, engines 502, 504, 506, and 508 of FIG. 5 and the modules 602, 604, 606, and 608 of FIG. 6 have been described as hardware, software, or a combination thereof. Such components may be implemented in a number of fashions. Looking at FIG. 6, the software may be processor executable instructions stored on the memory resource 630, which is a tangible, non-transitory computer readable storage medium, and the hardware may be electronic circuitry, such as processor resource 632, for executing those instructions. The processor resource 632, for example, may include one or multiple processors. Such multiple processors may be integrated in a single device or distributed across devices. For example in reference to FIG. 7, the processor resource 632 may be distributed across any combination of server devices 792 and client devices 794. The memory resource 630 may be said to store program instructions that when executed by processor resource 632 implements the system 600 in FIG. 6. The memory resource 630 may be integrated in the same device as processor resource 632 or it may be separate but accessible to that device and processor resource 632. The memory resource 630 may be distributed across devices, such as server devices 792 and client devices 794 of FIG. 7. The memory resource 630 and the experience store 610 may represent the same physical medium unless otherwise described herein.

In one example, the program instructions may be part of an installation package that when installed may be executed by processor resource 632 to implement the system 600. In that example, the memory resource 630 may be a portable medium such as a CD, DVD, or flash drive or memory maintained by a server device, such as server device 792 of FIG. 7, from which the installation package may be downloaded and installed. In another example, the program instructions may be part of an application or applications already installed. Here, the memory resource 630 may include integrated memory such as a hard drive, solid state drive, or the like.

FIG. 7 depicts example environments in which various examples for processing an action may be implemented. The environment 790 is shown to include a system 700 for processing an action. The system 700 (described herein with respect to FIGS. 5 and 6) may represent generally hardware, software, or a combination thereof configured to process an action. The system 700 may include a constraint engine 702, a complexity engine 704, a workflow engine 706, a resource engine 708, and an experience store 710 that may be the same as the constraint engine 502, the complexity engine 504, the workflow engine 706, the resource engine 508, and the experience store 510, respectively, and, for brevity, the associated descriptions are not repeated. The system 700 may be integrated into a server device 792 or a client device 794. The system 700 may be distributed across server devices 792, client devices 794, or a combination of server devices 792 and client devices 794. The environment 790 may be a cloud computing environment. For example, any combination of the system 700, server device 792, and client devices 794 may be a virtual instance and/or may reside and/or execute on a cloud. The environment 790 may include a cloud computing environment, such as a cloud network 720.

In the example of FIG. 7, a server device 792 may access a client device 794. The server devices 792 may represent generally any computing devices configured to respond to a network request received from the client device 794. For example, a server device 792 may be a virtual machine of the cloud network 720 providing the service and the client device 794 may be a computing device configured to access the cloud network 720 and receive and/or communicate with the service. A server device 792 may include a web server, an application server, or a data server. The client devices 794 may represent generally any computing devices configured with a browser or other application to communicate such requests and receive and/or process the corresponding responses. A link 796 may represent generally one or any combination of a cable, wireless, fiber optic, or remote connections via a telecommunications link, an infrared link, a radio frequency link, or any other connectors of systems that provide electronic communication. The link 796 may include, at least in part, intranet, the Internet, or a combination of both. The link 796 may also include intermediate proxies, routers, switches, load balancers, and the like.

Referring to FIGS. 5-7, the engines 502, 504, 506, and 508 and/or the modules 602, 604, 606, and 608 (as represented as engines 702, 704, 706, and 708 of FIG. 7) may be distributed across server devices 792, client devices 794, storage mediums, or a combination thereof. The engines 502, 504, 506, and 508 and/or the modules 602, 604, 606, and 608 may complete or assist completion of operations performed in describing another engine 502, 504, 506, and 508 and/or the module 602, 604, 606, and 608. The engines 502, 504, 506, and 508 and/or the modules 602, 604, 606, and 608 may perform the example methods described in connection with FIGS. 1-4.

Although the flow diagrams of FIGS. 1-4 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present description has been shown and described with reference to the foregoing examples. It is understood, however, that other forms, details, and examples may be made without departing from the spirit and scope of the invention that is defined in the following claims.

What is claimed is:

1. A method for processing an action comprising:
determining an attribute of the action;
evaluating a complexity value of the action based on the attribute and independent of a system state; and
positioning the action in a workflow based on a time unit length for execution of the action, the time unit length associated with the complexity value and the workflow including a pattern for execution based on the complexity value.

2. The method of claim 1, comprising:
determining a constraint on execution of the action or an absence of the constraint;
gathering information associated with the attribute of the action from an experience store to determine the complexity value;
determining the workflow based on the constraint, the complexity value, and the system state;
determining a processor resource to execute the action based on the system state, the processor resource selected from a plurality of processor resources of a distributed system; and
updating the experience store with an actual execution time of the action.

3. The method of claim 2, comprising:
grouping the action into a workflow group based on the attribute, the workflow group to contain a plurality of actions associated with the attribute;
determining the action depends on execution of a first action of the plurality of actions, the action positioned in the workflow to execute after the first action of the plurality of actions; and
determining the action is concurrently executable with a second action of the plurality of actions, the action positioned in the workflow to execute concurrently with the second action of the plurality of actions based on the time unit length.

4. The method of claim 3, comprising:
estimating the time unit length based on at least one of a set of historical data related to prior execution history associated with the attribute, a set of prediction data related to an estimation of the time unit length based the attribute, and a set of seed data to establish a prediction starting point based on the set of historical data related to the attribute; and
using a numerical optimization technique to minimize the execution time of the workflow of the plurality of actions based on the time unit length.

5. The method of claim 3, comprising:
initializing a workflow determination at runtime based on at least one of:
receiving a second action request; and
receiving a system event associated with the system state; and
establishing the workflow, based on a dependency of the action and a concurrency of the action, by at least one of:
creating the workflow; and
selecting the workflow from a plurality of workflows.

6. A system for processing an action comprising:
a constraint engine to determine a constraint on execution of the action;
a complexity engine to evaluate a complexity value of the action based on an attribute of the action and independent of a system state; and
a workflow engine to position the action in a workflow based on a time unit length for execution of the action, the time unit length associated with the complexity value and the workflow based on the complexity value of the action and the constraint on execution.

7. The system of claim 6, comprising a resource engine to monitor the system state of a cloud network, the workflow engine to position the action in a workflow based on the system state, the complexity value of the action, and the constraint on execution.

8. The system of claim 6, wherein the complexity engine is to:
gather a set of complexity information related to the action from an experience store based on the attribute, the experience store to contain a set of historical data; and predict the time unit length for execution of the action based on the complexity value derived from the set of complexity information.

9. The system of claim 8, wherein the workflow engine is to:
apply a priority to the action to determine the position of the action in the workflow, the priority of the action determined based on at least one of an action request and the set of historical data of the experience store.

10. The system of claim 6, wherein the workflow engine is to:
apply a workflow rule to the attribute of the action during runtime, the workflow rule based on at least one of a set of program-defined logic, a set of query-defined logic, a set of system-defined logic, and a set of machine-learning logic; and
position the action in a second workflow, the second workflow to differ from the workflow based on the workflow rule applied to the attribute.

11. A computer readable medium including a set of instructions stored thereon that when executed by a processor resource implement a system comprising a constraint module, a complexity module, and a workflow module wherein:
the constraint module is executable by the processor resource to:
determine a constraint on execution of the action, the complexity module is executable by the processor resource to:
evaluate a complexity value of the action based on an attribute of the action and independent of a system state; and
the workflow module is executable by the processor resource to:
position the action in a workflow based on a time unit length for execution of the action, the time unit length associated with the complexity value and the workflow based on the complexity value of the action and the constraint on execution.

12. The medium of claim 11, comprising a resource module, wherein the resource module is executable by the processor resource to monitor the system state of a cloud network and the workflow module is executable by the processor resource to position the action in a workflow based on the system state, the complexity value of the action, and the constraint on execution.

13. The medium of claim 11, wherein the complexity module is executable by the processor resource to:
gather a set of complexity information related to the action from an experience store based on the attribute, the experience store to contain a set of historical data; and
predict the time unit length for execution of the action based on the complexity value derived from the set of complexity information.

14. The medium of claim 13, wherein the workflow module is executable by the processor resource to compare a set of base information to the set of complexity information to interpret a complexity value difference between the action and a previous action having the attribute, the set of base information related to the complexity value of the previous action and retrievable from the experience store, the experience store to contain at least one of:
a set of heuristic data related to discovery of the complexity value of the action;
a set of benchmark data related to a point of reference for the complexity value of the action; and
a set of test data related to the previous action.

15. The medium of claim 11, wherein
the complexity module is executable by the processor resource to:
derive the attribute from an action request based on at least one of a first set of program-defined logic, a first set of query-defined logic, a first set of system-defined logic, and a first set of machine-learning logic; and
the workflow module is executable by the processor resource to:
apply a workflow rule to the attribute of the action during runtime, the workflow rule based on at least one of a second set of program-defined logic, a second set of query-defined logic, a second set of system-defined logic, and a second set of machine-learning logic; and
position the action in the workflow during runtime based on the workflow rule applied to the attribute.
